(19) United States
(12) Patent Application Publication
(10) Pub. No.: US 2025/0075026 A1
(43) Pub. Date: Mar. 6, 2025

(54) FLAME RETARDANT FLEXIBLE POLYURETHANE FOAM FOR AUTOMOTIVE SEATING

(71) Applicant: DOW GLOBAL TECHNOLOGIES LLC, Midland, MI (US)

(72) Inventors: Silvia SCUSSOLIN, Correggio (IT); Maria Serena SCHENETTI, Correggio (IT); Alessio SABADINI, Correggio (IT); Sabrina FREGNI, Correggio (IT)

(21) Appl. No.: 18/714,112

(22) PCT Filed: Dec. 5, 2022
(86) PCT No.: PCT/US2022/051776

§ 371 Date: May 29, 2024

(30) Foreign Application Priority Data
Dec. 9, 2021 (IT) 102021000030947

(51) Int. Cl. C08G 18/66; C08G 18/10; C08G 18/18; C08G 18/32; C08G 18/48; C08G 18/50; C08J 9/14

(52) U.S. Cl. CPC C08G 18/6688; C08G 18/10; C08G 18/1841; C08G 18/3275; C08G 18/482; C08G 18/4837; C08G 18/5024; C08J 9/146; C08G 2110/0008; C08G 2110/0083; C08J 2201/022; C08J 2203/142; C08J 2205/06; C08J 2375/08

(57) ABSTRACT

The present invention provides flexible and integral skin-containing polyurethane foams and two-component foam forming compositions for making them that comprise an aromatic polyisocyanate component, such as a methylene di(phenyl isocyanate), and a polyol component of an autocatalytic aliphatic polyether polyol and a melt modifying catalyst, such as potassium acetate, that exhibit excellent inherent flame retardant properties, passing exacting tests prescribed by the UN/ECE 118.02, Annexes 6, 7 and 8. The foam forming compositions may be all liquid and thus readily processible. Further, the two-component foam forming compositions and the polyurethane foams therefrom are halogen and melamine free and exhibit low emissions and low odor.

### FIELD

The present invention relates to inherently fire-resistant flexible and integral skin-containing polyurethane foams, and to foam forming compositions for making them comprising no flame retardant additive. More particularly, the present invention relates to the low density inherently flame-retardant flexible polyurethane foams as well as integral skin-containing polyurethane foams and to liquid two-component foam forming compositions for forming the polyurethane foams comprising an aromatic polyisocyanate, an autocatalytic aliphatic polyether polyol having at least one tertiary amine group, and a melt modifying catalyst, such as an amine free catalyst, for example, an alkali metal salt.

### INTRODUCTION

Fire safety, for example, by controlling flame development and propagation remains a critical technical and safety requirement for materials used within a vehicle. Accordingly, all materials used in the high-risk areas of a vehicle, such as the interior car and bus cabin and engine compartment must comply with international flammability standards. Regulation No. 118 of the United Nations Economic Commission for Europe (UN/ECE), the “Uniform technical prescriptions concerning the burning behaviour and/or the capability to repel fuel or lubricant of materials used in the construction of certain categories of motor vehicles” including the 02 series of amendments, effective Jul. 26, 2012, (ECE 118.02) seeks to insure the fire safety of such safety of all materials used in coaches and intercity all-seater buses within the European Union. ECE 118.02 governs use of materials or components used in areas of the vehicle with a high flammability risk, such as the engine bay and heater compartments, or in high fire impact areas, such as in interior cabin spaces. The materials used in vehicle interiors and engine compartments may further enhance the acoustic performance of the vehicle.

The standards mandated by ECE 118.02 require a passing rating in 3 different fire resistance tests, described in the Annexes 6, 7 and 8 of the regulation. The standards are thus very demanding for the flexible polyurethane foams conventionally used as cushion material, for example, in bus transportation. While most flexible polyurethane foams easily pass Annex 6 (horizontal burning rate), they still fail Annex 7 (melting behavior) and 8 (vertical burning rate). Accordingly, it would be desirable to provide a flexible polyurethane foam that meets the mechanical and physical specifications of automotive original equipment manufacturers (OEMs) and that also passes the tests in all of Annexes 6, 7 and 8 of ECE 118.02.

JP2008001805A to Toyo Tire & Rubber Co Ltd (Toyo Tire) discloses a polyol composition for producing a rigid polyurethane foam having excellent foam strength, flame-retardancy and heat-insulation. The foam forming composition disclosed comprises a polyol component of from 10 to 30 wt. % of an ethylene oxide adduct of ethylenediamine having a hydroxyl value of 600-810 mg KOH/g) and 20-60 wt. % of an ethylene oxide or propylene oxide adduct of toluenediamine, an amine catalyst and a melt modifying catalyst. Toyo Tire discloses only rigid foams not suitable as flexible forms, or for use in seating, as cushions, supports or in other flexible foam applications. Further, the aromatic polyols of Toyo Tire may be detrimental to the flexibility of a foam made therefrom and may lead to processability issues, such as high viscosity and phase separation in formulation and molding, and to hydrolysis of resins and other polyols contained in the foam forming composition.

The present inventors have endeavored to provide a flame retardant polyurethane foam that passes each of Annexes 6, 7 and 8 of ECE 118.02 and that is free of solid flame retardant additives, and a composition for making such foams that is readily processible.

### SUMMARY

In accordance with the present invention, a two-component foam forming composition for making a fire-resistant polyurethane foam comprises:
a polyisocyanate component of:
(a) one or more aromatic polyisocyanates, preferably, methylene di(phenyl isocyanate) (MDI), an oligomer of MDI, a carbodiimide modified MDI, a uretonimine modified MDI, a prepolymer of MDI, or a mixture of two or more thereof; and,
   as a separate component,
a polyol component of:
(b)(i) from 8 to 60 wt. %, or, preferably, from less than 10 to 55 wt. %, or, from 10 to 40 wt. %, based on the total weight of the polyol component, of one or more autocatalytic aliphatic polyether polyols containing at least one tertiary amine group, or, preferably, from 2 to 8 tertiary amine groups, or, more preferably, having 3 or more tertiary amine groups, or, even more preferably, having 4 or more tertiary amine groups, having an hydroxyl number as determined in accordance with ASTM D4274 of from 15 to 200 mg KOH/g and having a hydroxyl functionality of from 1 to 8, or, preferably, from 2 to 8 or, more preferably, from 2 to 6;
(b)(ii) from 31.15 to 91.35 wt. %, or, preferably, from 36.15 to 91.35 wt. %, or, from 21.15 to 68.35 wt. %, based on the total weight of the polyol component, of one or more aliphatic polyether polyols having a hydroxyl functionality of from 2 to 6, or, for example, from 3 to 6 and a hydroxyl equivalent weight (HEW) of from 800 to 2,500;
(c) from 0.15 to 0.35 wt. %, based on the total weight of the polyol component, of one or more melt modifying catalysts containing an alkali metal, preferably, an alkali metal salt, more preferably, an alkali metal carboxylate, even more preferably, a potassium carboxylate, such as potassium acetate;
(e) from 0.5 to 15 wt. %, based on the total weight of the polyol component, of water, a physical blowing agent, or a combination of water and a physical blowing agent, which may be chosen from from 0.5 to 7 wt. %, based on the total weight of the polyol component, of water as a blowing agent in flexible foam forming compositions, or a blowing agent having no more than 0.3 wt. % of water, based on the total weight of the polyol component in foam forming compositions for forming an integral skin-containing foam; and,
the foam forming composition has an isocyanate index ranging from 60 to 120, or preferably from 70 to 110, or, preferably, from 60 to 100 in flexible foam forming compositions,
wherein the two-component foam forming composition is free of solid flame retardant additives, or, preferably, is free of all of melamine flame retardant additives and halogen containing flame retardant additives, or, more preferably, is free of any added flame retardant additives, and, further wherein, all wt. % s add up to 100%. The polyol component of the two-component composition of the present invention may further comprise:
(d) from 0.2 to 1.5 wt. %, based on the total weight of the polyol component, of one or more additives chosen from a (i) a tertiary amine catalyst, for example, a non-emissive or non-fugitive tertiary amine catalyst, such as one containing an isocyanate reactive group, for example, hydroxyl group or a primary or secondary amine group; (ii) a silicon containing surfactant; or (iii) one or more crosslinkers, such as diethylene glycol, or, preferably, at least 0.2 wt. %, based on the total weight of the polyol component of each of the (ii) silicon containing surfactant and the (iii) crosslinker, or, more preferably, at least 0.2 wt. %, based on the total weight of the polyurethane foam except for the weight, in condensed form, of the (a) one or more aromatic polyisocyanates, of each of the (i) tertiary amine catalyst, the (ii) silicon containing surfactant and the (iii) one or more crosslinkers.

The polyol component of a two-component foam forming composition for forming an integral skin-containing polyurethane foam may further comprise:
(b)(iii) from 0.05 to 13 wt. %, or, preferably, at least 0.2 wt. % of one or more hydroxyl terminated cross linkers having a hydroxyl functionality of from 2 to 4 and a hydroxyl equivalent weight (HEW) of from 25 to 100.

In accordance with another aspect of the present invention, an inherently fire-resistant polyurethane foam comprises:
(a) in condensed form, one or more aromatic polyisocyanates, preferably, a methylene di(phenyl isocyanate) (MDI), an oligomer of MDI, a carbodiimide modified MDI, a uretonimine modified MDI, a prepolymer of MDI, or a mixture of two or more thereof;
(b)(i) in condensed form, from 8 to 60 wt. %, or, preferably, from less than 10 to 55 wt. %, or, from 10 to 40 wt. %, based on the total weight of the polyurethane foam except for the weight, in condensed form, of the (a) one or more aromatic polyisocyanates, of one or more autocatalytic aliphatic polyether polyols containing at least one tertiary amine group, or, preferably, from 2 to 8 tertiary amine groups, or, more preferably, having 3 or more tertiary amine groups, having an hydroxyl number as determined in accordance with ASTM D4274 of from 15 to 200 mg KOH/g and having a hydroxyl functionality as determined in accordance with from 1 to 8, or, preferably, from 2 to 8 or, more preferably, from 2 to 6;
(b)(ii) in condensed form, from 38.15 to 89.85 wt. %, or, preferably, from 43.15 to 89.85 wt. %, or, from 68.15 to 29.85 wt. %, based on the total weight of the polyurethane foam except for the weight, in condensed form, of the (a) one or more aromatic polyisocyanates, of one or more aliphatic polyether polyols having a hydroxyl functionality of from 3 to 6 and a hydroxyl equivalent weight of from 800 to 2,500; and,
(c) dispersed within the polyurethane foam from 0.15 to 0.35 wt. %, based on the total weight of the polyurethane foam except for the weight, in condensed form, of the (a) one or more aromatic polyisocyanates, of one or more melt modifying catalyst containing an alkali metal, preferably, an alkali metal salt, more preferably, a potassium carboxylate, such as potassium acetate,
wherein the polyurethane foam comprises free hydroxyl groups in the amount of from to 0 to 66.7% of the total number, in condensed form, of isocyanate groups in the foam, including twice the number of any dimers of any isocyanate groups in the foam and three times the number of any trimers of isocyanate groups in the foam, and,
   further wherein, the polyurethane foam is free of solid flame retardant additives, or, preferably, is free of melamine flame retardant additives, or, preferably, is free of halogen containing flame retardant additives and phosphorus containing flame retardant additives, or, more preferably, is free of melamine and any flame retardant additives and any added flame retardant additives, and, still further wherein, all wt. % s add up to 100%. The polyurethane foam of the present invention may have a density as determined in accordance with ISO 845 of from 35 to 700 kg/m³ or, preferably, from 50 to 500 kg/m³. Further, a flexible polyurethane foam of the present invention may have a resilience as determined in accordance with ASTM-D3574-16 (2016) of from 40 to 65% when water is use as sole chemical blowing agent.

An integral skin-containing polyurethane foam may further comprise, in condensed form:
(b)(iii) from 0.05 to 13 wt. %, or, preferably, at least 0.2 wt. %, based on the total weight of the polyurethane foam except for the weight, in condensed form, of the (a) one or more aromatic polyisocyanates, of one or more hydroxyl terminated cross linkers having a hydroxyl functionality of from 2 to 4 and a hydroxyl equivalent weight (HEW) of from 25 to 100. Still further, an integral skin-containing polyurethane foam may have a higher density outer skin hardness as determined in accordance with ASTM D2240, Shore A of from 20 to 70 when a physical blowing agent is used and water blowing agent content is 0.3 wt. % or less.

The polyurethane foam of the present invention may further comprise:
(d) dispersed within the polyurethane foam, from 0.2 to 1.5 wt. %, based on the total weight of the polyurethane foam except for the weight, in condensed form, of the (a) one or more aromatic polyisocyanates, of one or more additives chosen from a (i) tertiary amine catalyst, for example, a non-emissive or non-fugitive tertiary amine catalyst, such as one containing, in condensed form, an isocyanate reactive group, for example, hydroxyl group or a primary or secondary amine group; (ii) a silicon containing surfactant; or (iii) one or more crosslinkers, such as diethylene glycol, or, preferably, at least 0.2 wt. %, based on the total weight of the polyurethane foam except for the weight, in condensed form, of the (a) one or more aromatic polyisocyanates, of each of the (ii) silicon containing surfactant and the (iii) one or more crosslinkers, or, more preferably, at least 0.2 wt. %, based on the total weight of the polyurethane foam except for the weight, in condensed form, of the (a) one or more aromatic polyisocyanates, of each of the (i) tertiary amine catalyst, the (ii) silicon containing surfactant and the (iii) one or more crosslinkers.

In accordance with the present invention, a 70 mm×70 mm×13 mm thick panel of the polyurethane foam passes each of the following tests specified by Regulation No. 118 of the United Nations Economic Commission for Europe (UN/ECE), including the 02 series of amendments, effective Jul. 26, 2012, (ECE 118.02);
(i) Annex 6 of ECE 118.02 with a horizontal burning rate of not more than 100 mm/minute;
(ii) Annex 7 of ECE 118.02 with a melting test rating of no ignition caused by the tested foam panel; and,
(iii) Annex 8 of ECE 118.02 with a vertical burning rate of not more than 100 mm/min.

### DETAILED DESCRIPTION

In accordance with the present invention, polyurethane (PU) foams that do not contain a flame retardant additive resist dripping and burning in presence of an ignition source. The present inventors have found that the combination of an autocatalytic polyether polyol and a melt modifying catalyst, such as potassium acetate, in the polyol component of a foam forming composition enables the making of polyurethane foams that meet the tests prescribed by the ECE 118.02 regulations. At the same time, the polyurethane foams retain a low emission and low odor performance when non-emissive or non-fugitive tertiary amine catalyst are used, and exhibit physical-mechanical properties acceptable to automotive and bus industries OEMs. Further, the foam forming compositions have a viscosity that enables optimum processing without requiring specialized equipment needed to process solids in foam formation. The foams are able to pass the ECE Regulation 118.02 tests without the use of solid flame retardant additives like melamine, expandable graphite, or any liquid phosphorus or halogen containing flame retardant additives, like trichloro polyphosphates. Thus, the foam forming compositions avoid the damage to foam processing equipment that solid additives cause. In testing, the resulting polyurethane foams of the present invention exhibited a burning behavior wherein melt drops were still produced, but those drops did not flame or ignite any of cotton held underneath a test foam panel as per Annex 7 of ECE 118.02. The melt modifying catalyst aided the flame extinguishing performance of the inventive foam panels, enabling a passing result in the Annex 6 and 8 tests of ECE 118.02, respectively, the horizontal combustion and vertical burning tests. In particular, by increasing foam melting upon burning, the fire resistance of the polyurethane foams was improved by catalyzing an alternative urethane bond decomposition reaction at a lower temperature and enabling a higher CO₂ emission through use of a Group I metal containing melt modifying catalyst, such as potassium acetate. In contrast to the foams of the present invention, typical polyurethane depolymerization leads to isocyanate release along with the formation of smoke and char as in equation (I), below. In accordance with the present invention, the polyurethane foams exhibited an alternative decomposition pathway as in equation (II), below, wherein the polymer quickly decomposes at a lower temperature (around 120° C. instead of 180° C.) with the release of CO₂. The increased melting of the foam allowed the foam to “escape” from the flame in the Annex 6 and 8 tests; and the higher carbon dioxide emissions from the foam on burning helped in extinguishing the fire in the Annex 7 test.

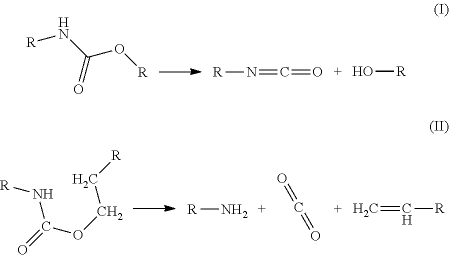

All ranges recited are inclusive and combinable. For example, a disclosed range of a hydroxyl functionality of from 1 to 8, or, preferably, from 2 to 8 or, more preferably, from 2 to 6, includes all of a hydroxyl functionality of from 1 to 8, or, from 1 to 2, or, preferably, from 2 to 8, or, more preferably, from 2 to 6, or, preferably, from 6 to 8.

Unless otherwise indicated, conditions of temperature and pressure are ambient temperature (21-24° C.), a relative humidity of 50%, and standard pressure (1 atm).

Unless otherwise indicated, any term containing parentheses refers, alternatively, to the whole term as if parentheses were present and the term without them, and combinations of each alternative. Thus, as used herein the term, “blowing agent(s)” and like terms is intended to include a blowing agent, or mixtures thereof.

As used herein, the term “ASTM” refers to publications of ASTM International, Conshohocken, Pa.

As used herein, the term “component” refers to a composition containing one or more ingredients which is combined with another component to start a reaction, polymerization, foam formation or cure. Components are kept separate until combined at the time of use or reaction

As used herein, the term “DIN” refers to publications of the Deutsches Institut fur Normung, the German Institute for Standardization, Berlin, Germany.

As used herein, the term “ISO” refers to the publications of the International Organization for Standardization, Geneva, CH. Further, the term “EN ISO” or ISO EN” refers to such publications in the English language.

As used herein, the term “exotherm” refers to heat generated by a reaction that results in a rising or a least a steady elevated temperature (above room temperature) without the addition of any heat.

As used herein, the term “hydroxyl number” in mg KOH/g of analyte refers to the amount of KOH needed to neutralize the acetic acid taken up on acetoylation of one gram of the analyte material as determined in accordance with ASTM D4274.

As used herein, the term “hydroxyl equivalent weight” or “equivalent weight” or “EW” of a given polyether polyol or polyol refers to calculated value as determined by the equation:

EW=56,100/hydroxyl number of a given polyol.

As used herein, unless otherwise indicated the term “hydroxyl functionality” refers to the number of hydroxyl groups in a given polyol and is defined as the number of hydroxyl groups in the initiator used to form the polyol. For example, a polyol from a glycerol initiator has three hydroxyl groups; and if all of the reactants used to make a polyol a difunctional, such as diols, glycols or alkylene oxides, then the hydroxyl functionality of the resulting polyol is two. For mixtures, including mixtures of initiators, the number of hydroxyl functional groups is the weighted average of the polyols in a given mixture. Accordingly, a polyol made from a 50:50 (w/w) mixture of sorbitol (having 5 OH groups) and glycerol (having three hydroxyl groups) will be (5·0.5+3·0.5) or (2.5+1.5) or 4.

As used herein, the term, “in condensed form” means the form of a given material or ingredient after completion of each of the foam forming and polyurethane forming reaction. As used herein, unless otherwise indicated, the term “isocyanate index” or simply “index” refers to the ratio of the number of equivalents of isocyanate functional groups to the number of equivalents of hydroxyl groups in a given polyurethane (foam) forming reaction mixture, multiplied by 100 and expressed as a number. For example, in a reaction mixture wherein the number of equivalents of isocyanate equals the number of equivalents of active hydrogen, the isocyanate index is 100. For the purpose of calculating the number of isocyanate groups, an isocyanurate is considered as having three (3) isocyanate groups per ring.

As used herein, the term “isocyanate reactive group” refers to an hydroxyl group or an amine group.

As used herein, the term “molecular weight” or “MW” of a given polyether polyol or polyol refers to a calculated value as determined by the equation:

$$MW = ( 56 , 100 / hydroxyl number ) \times the hydroxyl functionality of a polyol .$$

As used herein, the term “polyisocyanate” refers to an isocyanate group containing material having two or more isocyanate functional groups, such as a diisocyanate, or a dimer or trimer thereof, or an oligomer thereof made by reaction of an excess of isocyanate with one or more diols.

As used herein, the term “solid material” refers to a crystalline or amorphous substance that at a temperature of from 21 to 25° C. and a pressure of 1 atmosphere does not flow perceptibly under moderate stress, has a definite capacity for resisting forces which tend to deform it, and under standard conditions and at a temperature of from 21 to 25° C. retains a definite size and shape.

As used herein, the term “total solids” or “solids” refers to everything in a given composition other than water, ammonia and any volatile solvents or materials which flash off or volatilize at below 60° C. and atmospheric pressure. As the foam forming compositions react to form flexible or integral skin-containing polyurethane foams, all polyols, diols and polyisocyanates become solids even if they comprise a liquid phase material before they react.

As used herein, the phrase “wt. %” stands for weight percent.

The polyurethane foams in accordance with the present invention may be made from foam forming compositions of a two-component reaction mixture of a polyisocyanate component, and a polyol component. Each of the two components of the foam forming compositions react to form a polyurethane or polycarbamate by a conventional condensation reaction of a hydroxyl group with an isocyanate group or an isocyanurate ring. As the reaction to form a polyurethane conforms to stoichiometric ratios of hydroxyl groups to isocyanate groups or one-third of isocyanurate rings, the relative ratios of any hydroxyl and any amine groups in the polyol component and isocyanate groups in the polyisocyanate component in the foam forming compositions of the present invention are the same as the relative ratios of the hydroxyl groups and isocyanate groups, in condensed form, in the polyurethane foams of the present invention. While the polyurethane foam of the present invention does not comprise water, physical blowing agents or volatiles that may be present in the polyol component of the foam forming compositions, the condensate of a polyol or polyisocyanate weighs less than the corresponding amount of a polyol and a polyisocyanate in a foam forming compositions; and the difference is the weight of water, or the blowing agents, or the combination of thereof in the foam forming composition. The other materials in the foam forming compositions of the present invention, including the (c) one or more melt modifying catalysts, the (d)(i) tertiary amine catalysts; the (d)(ii) silicon containing surfactants, and (d)(iii) crosslinkers all remain in the polyurethane foams in the same relative proportions as in the foam forming compositions.

In forming the polyurethane foams of the present invention, all of the (a) polyisocyanate should be reacted in the forming of the polyurethane, or polyurea so that the foams can be more flexible and less dense, owing to the presence of aliphatic polyether chains. The foam forming compositions in accordance with the present invention thus may have an isocyanate index ranging from 60 to 120 or, from 70 to 110, such as, preferably, 100 or less in flexible foam forming compositions. Likewise, the polyurethane foams of the present invention may comprise the (a) one or more aromatic polyisocyanates in condensed form in amounts such that free hydroxyl groups in the foam amount to from 0 to 66.7% of the total number of carbamate group equivalents in the foam, counting a condensed isocyanurate ring as three carbamate groups.

The polyisocyanate component of the two-component foam forming composition of the present invention comprises (a) one or more aromatic polyisocyanates, such as an aromatic diisocyanate, or, preferably, a methylene di(phenyl isocyanate) (MDI), an oligomer of MDI, a carbodiimide modified MDI, a uretonimine modified MDI, a prepolymer of MDI, or a mixture of two or more thereof. Suitable aromatic isocyanates may include, for example, a blend of MDI and a polymeric MDI, such as a dimer or trimer of MDI, or a polyisocyanate functional urethane prepolymer, such as the reaction product of an excess of MDI with a diol. Examples of other suitable aromatic diisocyanates or polyisocyanates in accordance with the present invention may include one or more of various MDI isomers, such as diphenylmethane-4,4′-diisocyanate or diphenylmethane-2,4′-diisocyanate; hydrogenated MDI, such as hydrogenated diphenylmethane-4,4′-diisocyanate or hydrogenated diphenylmethane-2,4′-diisocyanate; methoxyphenyl-2,4-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, 4,4′-dimethyldiphenylmethane-2,2′,5,5′-tetraisocyanate. Diphenylmethane-4,4′-diisocyanate, diphenylmethane-2,4′-diisocyanate and mixtures thereof are generically herein referred to as “MDI”.

The polyol component of the two-component foam forming compositions of the present invention comprises (b)(i) at least one autocatalytic aliphatic polyether polyol having an hydroxyl number as determined in accordance with ASTM D-4274 of from 15 to 200 mg KOH/g. The equivalent weight of the (b)(i) at least one autocatalytic aliphatic polyether polyol may range from 250 to 3500, such as from 280 to 2000. The autocatalytic aliphatic polyether polyol allows for the reduction or elimination of added catalysts in PU foams; thus, autocatalytic aliphatic polyether polyols enable the provision of polyurethane foams that meet desirable physical and mechanical properties, such as those demanded by automotive OEMs, as well as low emissions (low volatile organics content (VOC) and low ammonia content) and low odor. However, the autocatalytic aliphatic polyether polyol has a limited viscosity so that it remains fluid before and during processing.

Autocatalytic aliphatic polyether polyols may be formed in the manner set forth in U.S. patent publication 2011/0319572, to Casati et al. by alkoxylation of at least one tertiary amine containing initiator molecule. For example, the (b)(i) one or more autocatalytic aliphatic polyether polyols of the present invention may be made from a tertiary (oligo)amine initiator and a difunctional aliphatic polyether polyol or aliphatic polyether diol.

Suitable (b)(i) autocatalytic aliphatic polyether polyols comprise at least one tertiary amine group, or, preferably, 2 or more, or, more preferably, 3 or more tertiary amine groups, or, even more preferably, 4 or more tertiary amine groups, and may have as many as 7 or 8 tertiary amine groups. The (b)(i) autocatalytic aliphatic polyether polyol may be made from a mixture of tertiary amine initiators.

Suitable aliphatic polyether diols useful for making an (b)(i) autocatalytic aliphatic polyether polyol of the present invention may have an hydroxyl number of from 15 to 800 mg KOH/g, such as from 30 to 800 mg KOH/g as determined in accordance with ASTM D4274, and may comprise an oligomer of ethylene oxide (EO), an oligomer of propylene oxide (PO) or an ethylene oxide endcapped polyether polyol, such as a polyoxyethylene-capped polyoxypropylene polyol, or, preferably, an EO endcapped PO. The polyether polyol may be made from 100% PO, or, preferably, a mixture of EO and PO containing from 10 to 20 wt. % of EO, based on the total weight of alkylene oxides used to form the aliphatic polyether polyol. Suitable tertiary amine initiators may include, for example, bis-3-aminopropyl methyl amine, a dimer thereof, or a trimer thereof; propoxylated bis-3-amino-propyl methyl amine, a dimer thereof, or a trimer thereof; 3,3′-diamino-N-methyldipropylamine, 2,2′-diamino N-methyldiethylamine, 2,3-diamino-N-methyl-ethyl-propylamine, an aminopropyl-terminated 2-propenenitrile-methanamine polymer having 8 or fewer amine groups, or a mixture thereof. Examples of suitable tertiary amines may have the following formulae (III) or (IV):

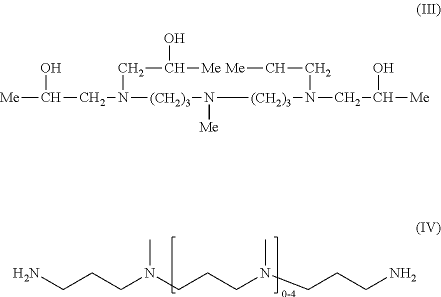

wherein, in the case of the tertiary amine of formula (IV), the (b)(i) autocatalytic aliphatic polyether polyol may comprise an adduct, such as an alkylene oxide adduct formed with the amine hydrogens of the tertiary amine, or it may comprise the reaction product of a diol extender or a polyether polyol and the tertiary amine.

Other examples of suitable tertiary amine initiators for making the (b)(i) autocatalytic aliphatic polyether polyols useful in the foam forming compositions may include, for example, any of triethanoldiamines, triethylene tetramines, or N,N-dimethyl-tris(hydroxymethyl)aminomethane.

Other examples of suitable tertiary amine initiators may be found, for example, in US patent application publication nos. US2004/0242832 A1 or US2008/0096993 A1, both to Casati et al.

One example of a preferred (b)(i) autocatalytic aliphatic polyether polyol may be a bis-3-aminopropyl methyl amine-initiated propoxylated/ethoxylated polyol, such as one made of a polyether diol of EO and PO containing, in condensed form, an EO amount of 17.5 wt. %, based on the total weight of alkylene oxides used to form the autocatalytic aliphatic polyether polyol, having an hydroxyl equivalent weight (HEW) of 1700, and a hydroxyl functionality of 4 (CAS no. 346426-38-83). Another example of a preferred (b)(i) autocatalytic aliphatic polyether polyol may be an ethoxylated, propoxylated and hydrogenated, aminopropyl-terminated 2-propenenitrile-methanamine polymer (of formula IV, above) having an hydroxyl equivalent weight (HEW) of 1547, a hydroxyl functionality of 4 and an EO content of 16.6 wt. %, based on the total weight of alkylene oxides used to form the autocatalytic aliphatic polyether polyol (Cas no.2055838-16-7). Examples of suitable autocatalytic polyether polyols commercially available are the various VORANOL™ Polyols made from a tertiary amine initiator, or SPECFLEX™ ACTIV 2306, all available from The Dow Chemical Company, Midland, MI.

When the (b)(i) autocatalytic aliphatic polyether polyol of the present invention is used in proper amounts, the foam forming compositions are processible and conform well to the molds in which the polyurethane foams are formed. In the polyol component of the foam forming compositions of the present invention, the (b)(i) autocatalytic aliphatic polyether polyol may comprise, for example, 50 wt. % of the polyol component. The amount of the (b)(i) autocatalytic aliphatic polyether polyol in the foam forming compositions of the present invention may range from 8 to 60 wt. %, or, from less than 10 to 55 wt. %, or, for example, from 10 to 40 wt. %, all based on the total weight of the polyol component.

In the polyurethane foams of the present invention, the total amount of the (b)(i) one or more autocatalytic aliphatic polyether polyols may range from 8 to 60 wt. %, or, from less than 10 to 55 wt. %, or, for example, from 10 to 40 wt. %, based on the total weight of the polyurethane foam except for the weight, in condensed form, of the (a) one or more aromatic polyisocyanates.

The polyol component of the foam forming composition further comprises (b)(ii) one or more aliphatic polyether polyols having an hydroxyl functionality of from 2 to 6 as a reactant. As used herein, the hydroxyl functionality or number of hydroxyl groups of each (b)(ii) aliphatic polyether polyol equals the number of hydroxyl groups in the initiator. Such aliphatic polyether polyols having an hydroxyl functionality of two may be formed from alkylene oxides, diols, glycols or oligomers thereof, such as by adducting an (oligo)diol or glycol with one or more alkylene oxides. Higher functional aliphatic polyether polyols can be made, for example, by adducting an initiator molecule having three or more hydroxyl groups with one or more alkylene oxides or reacting the initiator with at least a stoichiometric amount of one or more diol or glycol extenders, optionally followed by adducting or endcapping the resulting polyether polyol with one or more alkylene oxides. Any aliphatic polyether polyols may be endcapped with an alkylene oxide, such as ethylene oxide, or can be extended to increase their molecular weight with one or more diols or diol extenders, such as alkylene oxides, glycols or oligomers thereof. Suitable initiators may have from two to six or, for example, from three to six hydroxyl groups. Initiators may include, for example, glycerol, erythritol, pentaerythritol, diglycerol, sugar alcohols like sorbitol, and other polyhydric alcohols. Suitable diol starters or extenders have exactly two hydroxyl groups and a molecular weight of up to 150. The molecular weight of the diol starter or extender may be, for example, 62 to 150, 62 to 125, 62 to 100 or 62 to 90. Examples of diol starters include ethylene glycol, 1,2-propylene glycol, 1,3-propylene glycol, 1,4-butane diol, diethylene glycol, thiodiethanol, N-methyl diethanolamine and dipropylene glycol. Suitable triol starters or initiators have exactly three hydroxyl groups and a molecular weight of up to 150, such as glycerol, triethanolamine or trimethylolpropane. The molecular weight of the triol initiator may be, for example 90 to 150. Difunctional aliphatic polyether polyols may be formed from solely diol starters; and, if triol starters are used, then trifunctional polyether polyols result. Preferably, the initiator used for making any of the (b)(ii) aliphatic polyether polyols suitable for use in the foam forming composition comprises glycerol.

Aliphatic polyether polyols (b)(ii) suitable for use in the foam forming compositions of the present invention may include polyether polyols having an hydroxyl number as determined in accordance with ASTM D4274 of from 25 to 200, or from 27 to 100, or, preferably, from 28 to 73. Because such polyether polyols comprise, in condensed form, one or more initiators, the aliphatic polyether polyols (b)(ii) of the foam forming compositions of the present invention comprise multiple polyether chains and have molecular weights (MW) that may range from 2400 to 7200, or, for example, from 3000 to 6000. Thus, suitable (b)(ii) aliphatic polyether polyol compositions may have an hydroxyl equivalent weight (HEW) of greater than 800. The HEW may be, for example, at least 800, at least 1000, at least 1200, or at least 1500 and may be, for example, up to 2500, up to 2400, or up to 2000. Such aliphatic polyether polyols may have 2 to 6, or 3 to 6 hydroxyl or isocyanate-reactive groups per molecule. An example of a suitable aliphatic polyether polyol may include, for example, the polyether of one or more initiators and any homopolymer of propylene oxide, any homopolymer of ethylene oxide, or any random copolymer of at least 70 wt. % propylene oxide and up to 30 wt. % ethylene oxide.

The amounts of the (b)(ii) one or more polyether polyols in the foam forming compositions of the present invention may range from 31.15 to 91.35 wt. %, or, preferably, from 36.15 to 91.35 wt. %, or, from 21.15 to 68.35 wt. %, based on the total weight of the polyol component.

In the polyurethane foams of the present invention, the amounts of the (b)(ii) one or more aliphatic polyether polyols may range from 31.15 to 91.35 wt. %, or, preferably, from 36.15 to 91.35 wt. %, or, from 21.15 to 68.35 wt. %, based on the total weight of the polyurethane foam except for the weight, in condensed form, of the (a) one or more aromatic polyisocyanates.

Preferably, the (b)(ii) one or more aliphatic polyether polyols in the polyol component of the foam forming compositions may be chosen from any of:
(i) a mixed feed polyether polyol having an ethylene oxide (EO) content of from 0.3 to 30 wt. % or, preferably, from 1 to 20 wt. %, and a propylene oxide (PO) content of from 70 to 99.7 wt. % or, preferably, from 80 to 99 wt. %, based on the total weight of all EO and PO in the polyether polyol;
(ii) a polyether polyol having a propylene oxide (PO) content of 100 wt. %, based on the total weight of all EO and PO in the polyether polyol;
(iii) a polyether polyol having one or more ethylene oxide (EO) end-capped propylene oxide (PO) polyether chains; or,
(iv) a aliphatic polyether polyol mixture chosen from a mixture of polyether polyols (i) and (ii), a mixture of polyether polyols (i) and (iii), a mixture of polyether polyols (ii) and (iii), or a mixture of polyether polyols (i), (ii) and (iii).

The polyol component of the foam forming compositions of the present invention further comprises (c) one or more melt modifying catalysts containing an alkali metal, in particular, an alkali metal salt melt modifying catalyst. The melt modifying catalyst enables a polyurethane decomposition mechanism at lower temperature and the release of additional carbon dioxide upon decomposition of the polyurethane upon ignition and can thereby effectively enable foams containing it to act in effect as a fire extinguisher. The melt modifying catalyst remains in the polyurethane foam after it is formed and so should comprise a catalyst that does not change form, such as via chemical reaction during foaming.

To create a low amine content and low emission polyurethane foam, the (c) one or more melt modifying catalysts preferably comprise a Group I or an alkali metal salt, such as an alkali metal carboxylate salt, for example, preferably, a Group I alkali metal or potassium carboxylate, or, more preferably, a Group I or alkali metal acetate, such as potassium acetate. Suitable commercially available melt modifying catalysts may include, for example, DABCO™ K2097 catalyst from Evonik industries, Essen, DE.

Suitable amounts of the (c) one or more melt modifying catalysts in the foam forming compositions of the present invention may range from 0.15 to 0.35 wt. %, based on the total weight of the polyol component.

In the polyurethane foams of the present invention, the amount of the (c) one or more melt modifying catalysts may range from 0.15 to 0.35 wt. %, based on the total weight of the polyurethane foam except for the weight, in condensed form, of the (a) one or more aromatic polyisocyanates.

The polyol component of the two-component foam forming compositions of the present invention may further comprise (d) from 0.2 to 1.5 wt. %, based on the total weight of the polyol component, of one or more additives chosen from a (i) tertiary amine catalyst; (ii) a silicon containing surfactant; or (iii) one or more crosslinkers, such as diethylene glycol. Preferably, the foam forming compositions comprise at least 0.2 wt. %, based on the total weight of the polyol component, of each of the (ii) silicon containing surfactant and the (iii) crosslinker, more preferably, at least 0.2 wt. %, based on the total weight of the polyol component, of the (a) one or more aromatic polyisocyanates, of each of the (i) tertiary amine catalyst, the (ii) silicon containing surfactant and the (iii) one or more crosslinkers.

Suitable (d)(i) tertiary amine catalysts for use in the foam forming compositions and foams of the present invention may include, for example, any non-emissive or non-fugitive tertiary amine catalysts, such as various bis(N,N-dimethyl-3-amino-propyl)amines, which improves surface cure in flexible molding; 3-(dimethylamino)propyl urea; or any tertiary amine catalysts containing an isocyanate reactive group, for example, a hydroxyl group or a primary or secondary amine group. In the polyurethane foams of the present invention, the non-emissive or non-fugitive tertiary amine catalysts will remain in condensed form, as they form a part of at least one carbamate group where they have reacted with an isocyanate.

Suitable (d)(ii) silicon containing surfactants for use in the foam forming compositions and foams of the present invention may include, for example, polyethoxylated polydialkysiloxanes and polyethoxylated block copolymers of organo-and diorgano-polysiloxanes.

Suitable (d)(iii) crosslinkers for use in the foam forming compositions and foams of the present invention may include, for example, diethanolamine (DEOA) or triethanolamine (TEOA). Suitable amounts of the (d)(i) non-emissive or non-fugitive tertiary amine catalysts, (d)(ii) silicon containing surfactants (d)(iii) and crosslinkers in the polyurethane foams of the present invention may range from (d) from 0.2 to 1.5 wt. %, based on the total weight of the polyurethane foam except for the weight, in condensed form, of the (a) one or more aromatic polyisocyanates. Preferably, the polyurethane foams of the present invention comprise at least 0.2 wt. %, based on the total weight of the polyurethane foam except for the weight, in condensed form, of the (a) one or more aromatic polyisocyanates, of each of the (i) non-emissive tertiary amine catalyst and the (iii) crosslinker, more preferably, at least 0.2 wt. %, based on the total weight of the polyurethane foam except for the weight, in condensed form, of the (a) one or more aromatic polyisocyanates, of the (a) one or more aromatic polyisocyanates, of each of the (i) tertiary amine catalyst, the (ii) silicon containing surfactant and the (iii) crosslinker.

The flexible polyurethane foams of the present invention are preferably fully water blown. integral skin-containing polyurethane foams may be foamed from physical blowing agents, such as, for example, low boiling hydrocarbons, low boiling fluorinated liquid alcanes and halogen containing alkenes, other low boiling organic chemicals, preferably, safer blowing agents such those that do not contain fluorine. Suitable amounts of the total (e) blowing agent in the foam forming compositions of the present invention range from 0.5 to 15 wt. %, based on the total weight of the polyol component. The integral skin-containing foam forming compositions comprise one or more physical blowing agents, and can comprise up to 0.3 wt. % or, preferably, up to 0.2 wt. %, based on the total weight of the polyol component, of water.

The foam forming compositions of the present invention may be free of solid materials and, thus, may be all-liquid, which means that they do not comprise materials which have a defined shape and that resist deformation at standard pressure (1 atm) and at 21 to 25° C. Thus, the flexible polyurethane foams of the present invention while formed from all liquid compositions, may be free of solid additives, which means that the foams comprise nothing that would have been solid in the compositions used to form them even if the foams themselves are a solid. The integral skin-containing foam forming compositions are free of melamines, and solid flame retardant additives; however, the integral skin-containing foam forming compositions may containing polyols comprising some solids, such as styrene acrylonitrile polymers.

The polyurethane foams may have a density as determined in accordance with ISO 845 of from 35 to 700 kg/m³ or, preferably, from 50 to 500 kg/m³. The flexible polyurethane foams may have a The polyurethane foam of the present invention may have a density as determined in accordance with ISO 845 of from 35 to 75 kg/m³ or, preferably, from 50 to 65 kg/m³.

In accordance with another aspect of the present invention, methods of making a fire-resistant polyurethane foam may comprise any method for forming a flexible or integral skin-containing foam from a two-component foam forming composition. The methods may comprise, for example:
combining the polyisocyanate component of the two-component foam forming composition with the polyol component thereof in a device that enables foam formation, such as a mixer equipped with a pump and separate feeds for each of the polyol component and the polyisocyante component, such as, for example, a low-pressure foaming machine; and,
further, may comprise pouring the resulting foam forming composition into an open mold or a closed mold, such as a mold under pressure greater than atmospheric pressure.

The fire-resistant polyurethane foams of the present invention may find use in cushions, seating, pads, coverings and panels, such as for automotive or mass transit uses where a low density product with fire resistance performance is required.

### EXAMPLES

The following examples illustrate the present invention. Unless otherwise indicated, all temperatures are ambient or room temperature (21-25° C.), all pressures are 1 atmosphere and relative humidity (RH) is 35%. Notwithstanding that the numerical ranges and parameters setting forth the broad scope of the invention are approximations; and numerical values set forth in the specific examples are reported as precisely as possible. Any numerical value inherently contains certain errors necessarily resulting from the standard variation found in their respective testing measurements.

The materials used in the Examples and not otherwise defined, below, are set forth in Tables 1A, 1B and 1C, below. Abbreviations used in the examples include: CE: Comparative Example; DEOA: Diethanolamine; EO: Ethylene oxide; FR: Flame Retardant Additive; HEW: Hydroxyl equivalent weight; NCO: Isocyanate; OH: hydroxyl; OHn: Hydroxyl Number; PO: propylene oxide.

TABLE 1A
Additive Materials

| Material | Description |
|---|---|
| Amine | Bis(N,N-dimethyl-3-amino-propyl)amine, |
| Catalyst 1 | POLYCAT ™ 15 amine catalyst, Evonik industries, |
| | Essen, DE (Evonik) |
| Amine | Triethylenediamine (33 wt. %) in Monoethylene |
| Catalyst 2 | Glycol, DABCO ™ EG Catalyst (Evonik) |
| Amine | 3-(dimethylamino)propyl urea, DABCO ™ NE 1070 |
| Catalyst 3 | Catalyst (Evonik) |
| Amine | Dimethylaminopropylamine, JEFFCAT ™ DMAPA |
| Catalyst 4 | (Huntsman Chemicals, Salt Lake City, UT (Huntsman) |
| Amine | N,N,N′,N′-tetramethyl-2,2′-oxybis(ethylamine), |
| Catalyst 5 | DABCO ™ MP 604 Catalyst (Evonik) |
| Amine | Triethylenediamine (33%) in Dipropylene Glycol; |
| Catalyst 6 | DABCO ™ 33 LV Catalyst |
| DEOA | Diethanolamine |
| Trimerization | 30 wt. % solution of potassium acetate in diethylene |
| Catalyst | glycol, DABCO ™ K2097 Catalyst (Evonik) |
| Acid Blocked | Acid blocked amine gelling catalyst containing 30 |
| Amine | wt. % water, NIAX ™ A300, Momentive Specialty |
| Catalyst | Chemicals, Philadelphia, PA (Momentive) |
| Silicone | TEGOSTAB ™ B 8715 LF2 surfactant (Evonik) |
| Surfactant 1 | |
| Silicone | Polyalkyleneoxide methylsiloxane Copolymer |
| Stabilizer | NIAX ™ L-2171 stabilizer (Momentive) |
| Silicone | VORASURF ™ DC 5164 Polysiloxane Surfactant, |
| Surfactant 2 | The Dow Chemical Company, Midland, MI (Dow) |
| Blowing agent | 1,1,1,3,3-Pentafluoropropane; ENOVATE ™ 245F |
| Crosslinker 1 | Diethylenglycol, The Dow Chemical Company, |
| | Midland, MI (Dow) |
| Crosslinker 2 | Monoethylenglycol, The Dow Chemical Company, |
| | Midland, MI (Dow) |
| Crosslinker 3 | Tripropylene glycol |

TABLE 1B
Polyols

| Material | Description |
|---|---|
| Polyether | Sorbitol and Glycerine initiated ethylene oxide endcapped |
| Polyol 1 | polyether polyol, SPECFLEX ™ NC 632 polyol (Dow); |
| | HEW: 1726: OH functionality: 4.7; 15 wt. % EO |
| Polyether | Glycerine initiated ethylene oxide endcapped polyether |
| Polyol 2 | polyol, SPECFLEX ™ NC 138 polyol (Dow); |
| | HEW: 2000: OH functionality: 3; 14.5 wt. % EO |
| Polyether | Glycerine initiated ethylene oxide and propylene oxide |
| Polyol 3 | polyether polyol, VORANOL ™ CP 1421 polyol (Dow) |
| | HEW: 1675: OH functionality: 3; 78 wt. % EO |
| Polyether | Hetero-polyether triol initiated propylene oxide and |
| Polyol 4 | ethylene oxide polyether polyol, IP 010 polyol (Dow); |
| | HEW: 2568: OH functionality: 3; 63.7 wt. % EO |
| Polyether | Glycerine initiated ethylene oxide endcapped polyether |
| Polyol 5 | polyol, VORANOL ™ CP 6001 polyol (Dow); |
| | HEW: 2040: OH functionality: 3; 14.9 wt. % EO |
| Polyether | Glycerine initiated ethylene oxide endcapped polyether |
| Polyol 6 | polyol, SPECFLEX ™ NC 702 polyol, (Dow); |
| | HEW: 2550: OH functionality: 3; 40% styrene |
| | acrylonitrile copolymer, 12.2 wt. % EO |
| Autocatalytic | Bis-3-aminopropylmethylamine initiated ethylene |
| Polyether | oxide endcapped polyether polyol, HEW: |
| Polyol 1 | 1700: OH functionality: 4; 17.5 wt. % EO 1700 |
| Autocatalytic | Aminopropyl-terminated 2-Propenenitrile-methanamine |
| Polyether | polymer initiated, ethylene oxide endcapped polyether |
| Polyol 2 | polyol SPECFLEX ™ Activ 2306 polyol (Dow), |
| | HEW: 1547: OH functionality: 4; 16.6 wt. % EO |

TABLE 1C
Polyisocyanates

| Material | Description |
|---|---|
| Polyisocyanate 1 | Monomeric 50 o, p-MDI/50 p, p-MDI, |
| | ISONATE ™ OP 50 Pure MDI (Dow) |
| Polyisocyanate 2 | Monomeric 30 o, p-MDI/70 p, p-MDI, |
| | ISONATE ™ OP 30 Pure MDI (Dow) |
| Polyisocyanate 3 | PolyCarbodiimide Adduct isocyanate, |
| | ISONATE ™ 143M |
| Polyisocyanate 4 | Monomeric p, p-MDI, ISONATE ™ 125M |
| Polymeric | Polymeric MDI VORANATE ™, |
| Polyisocyanate 1 | M 2940 Polymeric MDI (Dow) |
| Polymeric | Polymeric MDI VORANATE ™, |
| Polyisocyanate 2 | M 220 Polymeric MDI (Dow) |
| NCO-terminated | 20.1 wt. % Polyisocyanate 1; 4.43 wt. % |
| PU prepolymer 1 | Polyisocyanate 2; 69.03 wt. % Polymeric |
| | Polyisocyanate; 5.2 wt. % Polyether Polyol 3; |
| | 0.62 wt. % Silicone Stabilizer; 0.62 wt. % |
| | Silicone Surfactant 2 (NCO 30.2 wt. %) (Dow) |
| NCO-terminated | 86.542 Polyisocyanate 4; 0.008% Benzoyl |
| PU prepolymer 2 | chloride; 13.45 Crosslinker 3 |
| NCO-terminated | 86.386% Polyisocyanate 3; 0.014% Benzoyl |
| PU prepolymer 3 | chloride; 13.6% Polyether Polyol 7 |
| NCO-terminated | 34.49% Polyisocyanate 3; 0.01% Benzoyl |
| PU prepolymer 4 | chloride; 5.5% Polyether Polyol 7; 40% |
| | NCO-terminated PU prepolymer 2; |
| | 20% Polymeric Polyisocyanate 2 |

TABLE 2
Comparative Examples 1 to 4 (Flexible foam)

| Example | CE1 | CE2 | CE3 | CE4 |
|---|---|---|---|---|
| POLYOL Component | | | | |
| Polyether Polyol 2 | 66.0 | 66.0 | 33 | 33.3 |
| Polyether Polyol 1 | 25 | 25 | 30 | 30 |
| Polyether Polyol 3 | 3.7 | 3.7 | 1.8 | 1.8 |
| Amine Catalyst 4 | 0.1 | 0.1 | — | — |
| DEOA | 0.33 | 0.33 | 0.33 | 0.33 |
| Amine Catalyst 1 | 0.3 | 0.3 | — | — |
| Amine Catalyst 2 | 0.1 | 0.1 | — | — |
| Amine Catalyst 5 | 0.1 | 0.1 | — | — |
| Amine Catalyst 3 | — | — | 0.6 | 0.1 |
| Silicone Surfactant 1 | 0.47 | 0.47 | 0.47 | 0.47 |
| Silicone Stabilizer | 0.1 | 0.1 | — | — |
| Melt modifying Catalyst | — | 0.2 | — | |
| Acid Blocked Amine Catalyst | — | — | — | 0.2 |
| Autocatalytic Polyether Polyol 1 | — | — | 30 | 30 |
| Water | 3.8 | 3.8 | 3.8 | 3.8 |
| Total Polyol Component | 100 | 100.2 | 100 | 100 |
| Isocyanate Component | NCO-terminated PU prepolymer 1 | | | |
| Isocyanate Index | 85 | | | |
| NCO/polyol weight ratio | 0.598 | 0.598 | 0.583 | 0.563 |

TABLE 3
Comparative Example 5 (Semi-rigid integral skin foam)

| Example | CE5 |
|---|---|
| POLYOL Component | |
| Polyether Polyol 5 | 38.50 |
| Polyether Polyol 6 | 6.00 |
| Polyether Polyol 3 | 2.50 |
| Crosslinker 1 | 0.50 |
| Crosslinker 2 | 6.00 |
| Autocatalytic Polyether Polyol 1 | 40.00 |
| Amine Catalyst 6 | 0.50 |
| Blowing agent | 6.00 |
| Trimerization Catalyst | — |
| Water | — |
| Total Polyol Component | 100.00 |
| Isocyanate Component | NCO-terminated PU prepolymer 4 |
| Isocyanate Index | 100 |
| NCO/polyol weight ratio | 0.431 |

TABLE 4
Examples 1 to 7 and CE5 (Flexible foam)

| Example | 1 | 2 | 3 | 4 | 5 | CE5* | 6 | 7 | 8 | 9 |
|---|---|---|---|---|---|---|---|---|---|---|
| POLYOL Component | | | | | | | | | | |
| Polyether Polyol 2 | 52.8 | 42.8 | 32.8 | 22.8 | 12.8 | 32.9 | 32.7 | 42.8 | 32.95 | 47.95 |
| Polyether Polyol 1 | 30 | 30 | 30 | 30 | 30 | 30 | 30 | 30 | 30 | 30 |
| Polyether Polyol 3 | 1.8 | 1.8 | 1.8 | 1.8 | 1.8 | 1.8 | 1.8 | 1.8 | 1.8 | 1.8 |
| DEOA | 0.33 | 0.33 | 0.33 | 0.33 | 0.33 | 0.33 | 0.33 | 0.33 | 0.33 | 0.33 |
| Amine Catalyst 3 | 0.6 | 0.6 | 0.6 | 0.6 | 0.6 | 0.6 | 0.6 | 0.6 | 0.45 | 0.45 |
| Silicone Surfactant 1 | 0.47 | 0.47 | 0.47 | 0.47 | 0.47 | 0.47 | 0.47 | 0.47 | 0.47 | 0.47 |
| Melt modifying Catalyst | 0.2 | 0.2 | 0.2 | 0.2 | 0.2 | 0.1 | 0.3 | 0.2 | 0.2 | 0.2 |
| Autocatalytic Polyether Polyol 1 | 10 | 20 | 30 | 40 | 50 | 30 | 30 | — | 30 | — |
| Autocatalytic Polyether Polyol 2 | — | — | — | — | — | — | — | 20 | — | 15 |
| WATER | 3.8 | 3.8 | 3.8 | 3.8 | 3.8 | 3.8 | 3.8 | 3.8 | 3.8 | 3.8 |
| Total Polyol Component | 100 | 100 | 100 | 100 | 100 | 100 | 100 | 100 | 99.85 | 94.85 |
| Isocyanate (NCO) Component | NCO-terminated PU prepolymer 1 | | | | | | | | | |
| NCO Index | 85 | | | | | | | | | |
| NCO/polyol weight ratio | 0.600 | 0.600 | 0.597 | 0.600 | 0.600 | 0.597 | 0.597 | 0.610 | 0.584 | 0.593 |

*Denotes Comparative Example.

TABLE 5
Examples 10 to 12 (Semi-rigid integral skin foam)

| | Example | Example | Example |
|---|---|---|---|
| Raw material | 10 | 11 | 12 |
| Polyether Polyol 5 | 38.20 | 38.20 | 38.50 |
| Polyether Polyol 6 | 6.00 | 6.00 | 6.00 |
| Polyether Polyol 3 | 2.50 | 2.50 | 2.50 |
| Crosslinker 1 | 0.50 | 0.50 | 0.50 |
| Crosslinker 2 | 6.00 | 6.00 | 6.00 |
| Autocatalytic Polyether Polyol 1 | 40.00 | 40.00 | 40.00 |
| Amine Catalyst 6 | 0.50 | 0.50 | 0.50 |
| Blowing agent | 6.00 | 6.00 | 6.00 |
| Trimerization Catalyst | 0.30 | 0.30 | 0.10 |
| WATER | — | — | — |
| Total Polyol Component | 100.00 | 100.00 | 100.10 |
| Isocyanate (NCO) Component | NCO- | NCO- | NCO- |
| | terminated | terminated | terminated |
| | PU pre- | PU pre- | PU pre- |
| | polymer 3 | polymer 4 | polymer 4 |
| NCO Index | 100 | 100 | 100 |
| NCO/polyol weight ratio | 0.448 | 0.438 | 0.433 |

Foam Formation: Foams were molded using a high-pressure machine Cannon A40, equipped with FPL 14 mixing head (Cannon USA, Cranberry Township, PA) and molding in prototype aluminum molds, heated by recirculating water at 50° C. and treated with a suitable conventional release agent. The demolding time was fixed at 5 minutes; and, after that, the foams were crushed to open all the internal cells, using a mechanical roller crusher. In general, the iso/polyol injection pressures were 160/160 bar, the temperature of both components was 25° C. and the output was of 250 g/s.

Test Methods: In the following examples, the following test methods were used. Mechanical and Physical properties: The properties tested are set forth in Table 6, below.

Low Emission: Foam emissions from off gassing were low where the compositions contained no fugitive catalysts or volatile solvents

Flame retardance: The flame retardance of each PU foam was tested in accordance with Annex 6, 7 and 8 of “Regulation No 118 of the Economic Commission for Europe of the United Nations (UN/ECE)—Uniform technical prescriptions concerning the burning behavior of materials used in the interior construction of certain categories of motor vehicles,” effective Apr. 6, 2005, 2d amendment effective Jul. 26, 2012 (ECE 118.02).

Annex 6: In the horizontal burning rate test, each 356×100×13 mm foam panel (cut, if needed, and tested with flush molded side facing down) was conditioned at room temperature and an RH of 50±5% for at least 24 hours and held horizontally in a specified U-shaped holder while exposing it to a Bunsen burner flame (tip touching the foam) for 15 seconds in a specified combustion chamber, the flame acting on the free end of the foam. Results recorded include the time at which the flame extinguishes or the time in which the flame passes a measured distance (burning rate). The burning rate (B) for each foam was calculated where the flame reached the last measuring point or the end of the foam and is determined as the quotient of the burnt distance and the time taken to burn this distance, expressed in millimeters per minute. B is given by the formula:

$$B = 60 s / t ( mm / min )$$

where ‘s’ is the burnt distance in millimeters and ‘t’ the time in seconds to burn distance ‘s’. Five foam panels were tested for each example, reporting the averages of the five results. An acceptable result includes a horizontal burning rate of not more than 100 mm/minute or where the flame extinguishes before reaching the last measuring point.

Annex 7: In the melt behavior test, each 70×70×13 mm foam panel (cut, if needed, and tested with flush molded side facing down) was conditioned at 23±2° C. and an RH of 50±5% for at least for 24 hours and held horizontally in a specified holder while exposing it to an electric radiator held above the panel at a 30 mm distance from the upper side of the panel, wherein the panel has a receptacle underneath the panel and having in it some cotton wool to verify if any drops are flaming. If the material melts or deforms, the height of the radiator is modified to maintain the distance of 30 mm. If the material ignites, the radiator is put aside for 3 seconds afterwards and is then brought back in position when the flame has extinguished. This procedure is repeated as frequently as needed during the first five minutes of the test. The result reported comprised a percentage (%) of each foam panel that passes the test. Four foam panels were tested for each example, reporting the averages of the four results. An acceptable result includes one wherein, when taking the worst test results into account, no drop is formed which ignites the cotton wool and, thus, no ignition is caused by the foam panel. A 100% passing score means that the foam panel does not form a drop which ignites cotton wool.

Annex 8: In the vertical burning rate test, each 356×100×13 mm foam panel (cut, if needed, and tested with flush molded side facing down) was conditioned at 23±2° C. and RH of 50±5% for at least for 24 hours and held in a vertical position in a specified clamp while exposing it to a Bunsen burner flame (tip touching the foam) and determining the speed of propagation of the flame over the foam, considering the ignition of marker threads attached horizontally in along the front face of the specimen at specified locations. The flame was applied to each specimen for 5 seconds. Ignition was deemed to have occurred if flaming of the specimen continued for 5 seconds after removal of the applied flame. If ignition did not occur, the flame was applied for 15 seconds to another conditioned foam panel.

The following times, in seconds, were measured:
(a) from the start of the application of the flame to severance of the first marker thread (‘t₁’);
(b) from the start of the application of the flame to severance of the second marker thread (‘t₂’);
(c) from the start of the application of the flame to severance of the third marker thread (‘t₃’);
   and the corresponding burnt distances (respectively, ‘d₁’, ‘d₂’, ‘d₃’), in millimeters.

The burning rate ‘V₁’ and the rates ‘V₂’ and ‘V₃’, if applicable, were calculated (for each panel if the flame reached at least the first marker thread) as:

$${V}_{i} = 60 {d}_{i} / {t}_{i} ( mm / min ) .$$

The highest burning rate of ‘V₁’, ‘V₂’ and ‘V₃’ was recorded. Five foam panels were tested for each example, reporting the averages of the five results. An acceptable result includes, taking the worst test results into account, one wherein the vertical burning rate was not more than 100 mm/minute.

TABLE 6
Fire Resistance of Comparative Foams

| | Performance | | | | |
|---|---|---|---|---|---|
| Test | Criteria | CE1 | CE2 | CE3 | CE4 |
| Annex 6- | <100 | PASS | PASS | Self-ext¹ | PASS (87.5 |
| horizontal | mm/min | (44 mm/ | (40.5 mm/ | | mm/min) |
| | | min) | min) | | (Near |
| | | | | | upper limit) |
| Annex 7- | Pass (%) | 75% | 100% | 75% | 100% |
| melting | | | | | |
| Annex 8- | <100 | Self- | FAIL | FAIL | PASS |
| vertical | mm/min | ext¹ | (fully | (fully | |
| | | | burned) | burned) | |

*Denotes Comparative Example;
¹Self-extinguishing.

TABLE 7
Fire Resistance of Foams (Semi-rigid integral skin foam)

| | Performance | |
|---|---|---|
| Test | Criteria | CE5 |
| Annex 6- | <100 mm/min | PASS (72 mm/min) |
| horizontal | | |
| Annex 7- | Pass (%) | 100% |
| melting | | |
| Annex 8- | <100 mm/min | FAIL |
| vertical | | |

TABLE 8
Fire Resistance of Foams (Flexible foam)

| | Performance | | | | | | | | |
|---|---|---|---|---|---|---|---|---|---|
| Test | Criteria | 1 | 2 | 3 | 4 | 5 | CE5* | 6 | 7 |
| Annex 6- | <100 | PASS | PASS | PASS | PASS | PASS | PASS | PASS | PASS |
| horizontal | mm/min | (self- | (55.5 | (self- | (60 | (self- | (self- | (self- | (48.0 |
| burn | | ext²) | mm/ | ext²) | mm/ | ext²) | ext²) | ext²) | mm/ |
| | | | min¹) | | min¹) | | | | min¹) |
| Annex 7- | 100% | PASS | PASS | PASS | PASS | PASS | FAIL | PASS | PASS |
| melt test | with no | | | | | | | | |
| | ignition | | | | | | | | |
| Annex 8- | <100 | PASS | PASS | PASS | PASS | PASS | PASS | PASS | PASS |
| vertical | mm/min | (Self- | (Self- | (Self- | (Self- | (Self- | (Self- | (Self- | (Self- |
| burn | | ext²) | ext²) | ext²) | ext²) | ext²) | ext²) | ext²) | ext²) |

¹last measuring point not reached;
²Self-extinguishing;
*Denotes Comparative Example.

TABLE 9
Fire Resistance of Foams (Semi-rigid integral skin foam)

| | Performance | | | |
|---|---|---|---|---|
| Test | Criteria | 10 | 11 | 12 |
| Annex 6- | <100 | PASS | PASS | PASS |
| horizontal | mm/min | (0 mm/min) | (0 mm/min) | (0 mm/min) |
| burn | | | | |
| Annex 7- | Pass (%) | 100 | 100 | 100 |
| melt test | | | | |
| Annex 8- | <100 | PASS | PASS | PASS |
| vertical | mm/min | (Self-ext²) | (Self-ext²) | (Self-ext²) |
| burn | | | | |

As shown in Tables 8 and 9, above, all foams in inventive Examples 1 to 7 passed each of the Annex 6, 7 and 8 tests set out in the regulation ECE 118.02 while maintaining acceptable physical and mechanical properties (including compression set and tear strength), aesthetic properties and processability. All foams in inventive Examples 10 to 12 passed each of the more critical, Annex 7 and 8 tests set out in the regulation ECE 118.02 Further, each of the inventive foams from 1 to 7 exhibited low emissions and odor as demonstrated by their compositions. In contrast, the foams of the Comparative Examples 1 to 5 either failed one or more of the ECE 118.02, Annex 6, 7 and 8 tests, or were not low emission foams because they contained fugitive tertiary amine catalysts that volatilize in foam formation, such as Amine Catalyst 2 and Amine Catalyst 5 which do not contain a group that is reactive with an isocyanate. All inventive example from 10 to 12 showed evident reduction of visual defects in comparison with comparative examples from 5 to 7.

TABLE 10
Physical-Mechanical Performance of Comparative Foams

| Test | Norm | CE1* | CE4 * | 8 | 9 |
|---|---|---|---|---|---|
| Density (kg/m³) | ASTM | 60 | 60 | 60 | 60 |
| | D1622 | | | | |
| Compression set | ASTM | 5.32% | 9.45% | 7.34% | 6.30% |
| | D3574¹ | | | | |
| Compression set— | ASTM | 8.40% | 9.19% | 10.26% | 8.99% |
| humid aged (200 | D3574¹ | | | | |
| hours @ 90° C. | | | | | |
| and 100% humidity) | | | | | |
| Compression set— | ASTM | 2.63% | 3.77% | 4.08% | 4.29% |
| heat aged (200 | D3574¹ | | | | |
| hours @ 90° C.) | | | | | |
| Tear strength | EN ISO | 1.74 | 1.94 | 1.84 | 2.38 |
| (N/cm) | 8067² | | | | |
| Tensile Strength | ASTM | 0.15 | 0.18 | 0.17 | 0.20 |
| (N/mm²) | D3574¹ | | | | |
| Elongation | ASTM | 89.18% | 89.15% | 81.25% | 88.26% |
| | D3574¹ | | | | |

*Denotes Comparative Example;
¹A 100 × 100 × 50 mm foam specimen having one skin;
²A 125 mm length × 25 mm width × 25 mm thickness specimen with a central cut of 50 mm length. Test speed is 100 mm/min.

As shown in Table 10, above, the inventive foams of Examples 8 and 9 comprising the inventive foam forming compositions provided flexible polyurethane foams having acceptable physical and mechanical properties. In fact, the mechanical and physical properties of the inventive foams are at least as good as those of conventional foams of Comparative Examples 1 and 2.

1. A two-component foam forming composition for making a fire-resistant polyurethane foam comprising:
a polyisocyanate component of:
(a) one or more aromatic polyisocyanates; and,
as a separate component,
a polyol component of:
(b)(i) from 8 to 60 wt. %, based on the total weight of the polyol component, of one or more autocatalytic aliphatic polyether polyols containing at least one tertiary amine group, having an hydroxyl number as determined in accordance with ASTM D4274 of from 15 to 200 mg KOH/g and having a hydroxyl functionality of from 1 to 8;
(b)(ii) from 31.15 to 91.35 wt. %, based on the total weight of the polyol component, of one or more aliphatic polyether polyols having a hydroxyl functionality of from 2 to 6, and a hydroxyl equivalent weight (HEW) of from 800 to 2,500;
(c) from 0.15 to 0.35 wt. %, based on the total weight of the polyol component, of one or more melt modifying catalyst;
(e) from 0.5 to 15 wt. %, based on the total weight of the polyol component, of water and/or physical blowing agents, and,
the two-component foam forming composition has an isocyanate index ranging from 60 to 120,
wherein the two-component foam forming composition is free of solid flame retardant additives and all wt. % s add up to 100%.

2. The two-component foam forming composition as claimed in claim 1, wherein (a) the one or more aromatic polyisocyanates comprise, in condensed form, a methylene di(phenyl isocyanate) (MDI), an oligomer of MDI, a carbodiimide modified MDI, a uretonimine modified MDI, a prepolymer of MDI, or a mixture of two or more thereof.

3. The two-component foam forming composition as claimed in claim 1, wherein the (b)(i) one or more autocatalytic aliphatic polyether polyols comprise from 2 to 8 tertiary amine groups.

4. The two-component foam forming composition as claimed in claim 1, wherein the (b)(i) one or more autocatalytic aliphatic polyether polyols comprise from 2 to 8 hydroxyl groups.

5. The two-component foam forming composition as claimed in claim 1, wherein the (b)(ii) one or more aliphatic polyether polyols has a hydroxyl functionality of from 3 to 6.

6. The two-component foam forming composition as claimed in claim 1 wherein the (c) one or more melt modifying catalysts comprise an alkali metal salt.

7. The two-component foam forming composition as claimed in claim 1, further comprising
(d) from 0.2 to 1.5 wt. %, based on the total weight of the polyol component, of one or more additives chosen from a (i) tertiary amine catalyst; (ii) a silicon containing surfactant; or (iii) a crosslinker.

8. The two-component foam forming composition as claimed in claim 7, comprising (d) at least 0.2 wt. %, based on the total weight of the polyol component, of each of the (ii) silicon containing surfactant and the (iii) crosslinker.

9. The two-component foam forming composition as claimed in claim 1, wherein the foam forming composition is free of all of solid materials, melamine flame retardant additives and halogen containing flame retardant additives.

10. An inherently fire-resistant polyurethane foam comprising:
(a) in condensed form, one or more aromatic polyisocyanates;
(b)(i) in condensed form, from 8 to 60 wt. %, based on the total weight of the polyurethane foam except for the weight, in condensed form, of the (a) one or more aromatic polyisocyanates, of one or more autocatalytic aliphatic polyether polyols containing at least one tertiary amine group, and having an hydroxyl number as determined in accordance with ASTM D4274 of from 15 to 200 mg KOH/g and having an hydroxyl functionality of from 1 to 8;
(b)(ii) in condensed form, from 38.15 to 89.85 wt. %, based on the total weight of the polyurethane foam except for the weight, in condensed form, of the (a) one or more aromatic polyisocyanates, of one or more aliphatic polyether polyols having a hydroxyl functionality of from 3 to 6 and an hydroxyl equivalent weight of from 800 to 2,500;
(b)(iii) from 0.05 to 13% of one or more hydroxyl terminated cross linkers having a hydroxyl functionality of from 2 to 4 and a hydroxyl equivalent weight (HEW) of from 25 to 100; and,
(c) dispersed within the polyurethane foam from 0.15 to 0.35 wt. %, based on the total weight of the polyurethane foam except for the weight, in condensed form, of the (a) one or more aromatic polyisocyanates, of one or more melt modifying catalysts;
wherein the polyurethane foam has a density as determined in accordance with ISO 845 of from 35 to 700 kg/m³ and comprises free hydroxyl groups in the amount of from 0 to 66.7% of the total number, in condensed form, of isocyanate groups in the foam, including twice the number of any dimers of any isocyanate groups in the foam and three times the number of any trimers of isocyanate groups in the foam, and,
further wherein, the polyurethane foam is free of solid flame retardant additives and all wt. % s add up to 100%.

11. The inherently fire resistant polyurethane foam as claimed in claim 10, wherein a 70 mm×70 mm×13 mm thick panel of the polyurethane foam passes each of the following tests specified by Regulation No. 118 of the United Nations Economic Commission for Europe (UN/ECE), including the 02 series of amendments, effective Jul. 26, 2012, (ECE 118.02):
(i) Annex 6 of ECE 118.02 with a horizontal burning rate of not more than 100 mm/minute;
(ii) Annex 7 of ECE 118.02 with a melting test rating of no ignition caused by the tested 10 foam panel; and,
(iii) Annex 8 of ECE 118.02 with a vertical burning rate of not more than 100 mm/min.
